(19) United States
(12) Patent Application Publication
(10) Pub. No.: US 2003/0053649 A1
(43) Pub. Date: Mar. 20, 2003

(54) Electroacoustic transducer

(76) Inventors: Richard Pribyl, Fischamend (AT); Hugo Lenhard-Backhaus, Wien (AT)

Correspondence Address: FRIEDRICH KUEFFNER, P.C., SUITE 910, 317 MADISON AVENUE, NEW YORK, NY, 10017, US

(21) Appl. No.: 10/251,649

(22) Filed: Sep. 20, 2002

(30) Foreign Application Priority Data
Sep. 20, 2001 (AT) A 1503/2001

(51) Int. Cl. H04R 25/00; H04R 9/08; H04R 11/04; H04R 17/02; H04R 19/04; H04R 21/02

(52) U.S. Cl. 381/369; 381/170

(57) ABSTRACT

An eletrostatic microphone capsule includes a diaphragm which is subjected to a sound field and is excited to oscillate by the sound field, and an electrode arranged at a distance from the diaphragm. The electrode has at least two areas with different charge densities. The at least two areas may include an at least essentially circular area and an at least essentially annular area. At least two of the areas of the electrode may operate in accordance with the capacitor principle, wherein different voltages are applied to the areas.

### BACKGROUND OF THE INVENTION

1. Field of the Invention

The present invention relates to electroacoustic transducers which operate on an electrostatic basis and as sound pickups and which are mounted in a microphone capsule. Independently of their physical manner of operation, such transducers have a diaphragm which is subjected to a sound field and is excited by the sound field to oscillate. Consequently, the invention is directed to an electrostatic microphone.

2. Description of the Related Art

The electrodes of an electrostatic transducer are an elastic diaphragm which is mounted with tension and a rigid electrode which is usually just called electrode. Together they form a capacitor whose electrical capacity is changed by pressure variations of the sound field which cause changes in the geometry. Since an electrical field is built up between the electrodes of the electrostatic transducer, it is possible to convert the capacity changes of the transducer into electrical voltage changes by means of an amplifier which is connected after the transducer.

From WO 97/39464 A it is known in the art to mount the rigid electrode on an electrically insulating support member which has indentations for increasing the air volume “behind” the diaphragm and, thus, to place less resistance against the oscillations of the diaphragm. Since the electrode is mounted on the already formed support member, it has “holes” which correspond to the indentations which, however, have a diameter of only a few micrometers, so that the electrode is macroscopically homogenous.

Electrostatic transducers, also called capsules, can be divided into two groups with respect to the manner in which the electrical field is applied between the electrodes:

Electrostatic transducers in which the charges which produce an electrical field are applied by means of an externally applied voltage (polarization voltage) i.e., capacitor capsules; and

Electrostatic transducers in which the electrical charge is “frozen” on the electrode or diaphragm, so that an externally applied voltage becomes obsolete as a result, i.e., electret capsules.

The electroacoustic properties of the electrostatic microphone capsules, i.e., the sensitivity, the frequency pattern of the sensitivity and the pickup pattern, are to a significant extent dependent on the oscillation behavior of the diaphragm. Since the diaphragm is subjected to different oscillation types (modes of oscillation) at different frequencies, and since the electrostatic transducers effect the conversion of the diaphragm movements into electrical voltage, it is clear that the sensitivity of the microphone transducer in dependence on the frequency is a function which is difficult to keep smooth.

In accordance with the prior art, the two types of electrostatic transducers have in common that the intensity distribution of the electrical field between the electrodes of the capacitor is unchangeable and homogenous in accordance with the configuration of the microphone capsule, and is only dependent on the respective manufacturing tolerances.

The intensity distribution of the electrical field is dependent on the geometric distribution of the charge carriers (electrons) on one of the electrodes, on the one hand, and the distance between the two electrodes, on the other hand, wherein a small change of the distance already results in a large change of the field intensity.

In electrostatic capsules which operate in accordance with the above-explained electret principle, one of the electrodes is covered with a thin electret layer. This layer is usually manufactured from a Teflon foil which has good storage properties for the electrical charge carriers because of its excellent insulation properties. This means that in such electrostatic capsules operating according to the electret principle, the distribution of the electrical field between the electrodes is determined by the distribution of the electrons on the Teflon layer of the electrode. In accordance with the prior art, the distribution of the carriers of the electrical charge, i.e., the electrons, was left purely to chance. In spite of the known fact that acoustic properties of the microphone capsules strongly depend on the distribution of the electrical charge on the Teflon layer, it has in the past not been possible to achieve a specifically targeted distribution of the electrons over the electrode surfaces because it was not even possible to measure the distribution which was obtained.

During the twentyfirst “Tonmeistertagung” (Sound Engineer Meeting) in Hannover, Germany, a measuring method was introduced which makes it possible to determine the distribution. An examination of existing electret capsules has shown that when charges are applied the distribution of the charges is frequently not uniform in spite of all precautions.

As an example for the effects of such deviations which are apparently unavoidable during the manufacture, it has been found that a lack of charges in the center area of an electrode results in a measurable change of the frequency pattern of a microphone capsule without taking into account the type of this change.

However, these nonuniform charge distributions are not always negative for the desired acoustic-electrical conversion; rather, they may make it possible, for example, to fully utilize physical boundary conditions. In this connection, it shall only be mentioned that in freely oscillating diaphragms, there is always the danger that in the case of large sound pressure amplitudes, the center portion of the diaphragm comes so close to the electrode that the electrostatic attraction forces exceed the elastic restoring forces and the diaphragm becomes “glued” with its central portion to the electrode. This danger does not exist in the border area in which the diaphragm is clamped, so that it is advantageous to have a charge distribution with a low charge density in the center and a high charge density in the border area.

In electrostatic transducers which operate in accordance with the capacitor principle, an external electrical voltage connected to the microphone capsule serves as the source for generating the electrical field between the electrodes of the capacitor. Since both electrodes are surfaces which are plane and smooth in the electrical sense, the geometric distribution of the electrical field between the electrodes is homogenous and not controllable from the outside. This means that in electrostatic transducers according to the capacitor principle, a uniform and practically unchanging charge distribution is ensured.

As mentioned above, both types of electrostatic capsules have in common that a change of the distance between the electrodes inevitably leads to a change of the intensity of the electrical field. It is known in the prior art to change the location of the electrodes in such a way that they are not parallel to each other. In WO 82/00745 A, a concave or convex electrode is described which is manufactured of metal and which, in electrostatic transducers which operate in accordance with the capacitor principle, produces different intensities of the electrical field between various locations of the electrodes, without taking into account the effects of these changes.

### SUMMARY OF THE INVENTION

Therefore, it is the object of the present invention to provide a geometric distribution of the intensity of the electrical field between the electrode and the diaphragm of electrostatic transducers, both those which operate in accordance with the electret principle and those which operate in accordance with the capacitor principle, which can vary within wide limits, for example, in accordance with the wishes of the manufacturer or the user.

In accordance with the present invention, this object is met by providing the electrode with at least two different areas which have different charge carrier densities.

In accordance with a development of the invention, the electrode may in its border area be constructed in accordance with the electret principle and in its central portion in accordance with the capacitor principle. This makes it possible to apply in the border area of the electrode in which must not be expected that the diaphragm becomes “glued” a significantly higher charge density than in the central area of the electrode which is susceptible to becoming “glued”.

In accordance with another embodiment, it is possible to construct the diaphragm in accordance with the capacitor principle, wherein, however, at least two areas of the electrode, preferably a central circular area and at least an annular area arranged concentrically to the central area, are electrically separated from each other and are supplied with different voltages, so that different charge densities are built up in the different areas.

In accordance with yet another embodiment of the invention, it is possible to apply in the border area of an electrode operating in accordance with the electret principle a higher charge intensity than in the central area and, thus, to increase the charge density in the border area.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a sectional view of a teflonized electrode of an electrostatic microphone transducer according to the electret principle;

FIG. 2 is a diagram showing the intensity distribution of the electrical field of the electrode of FIG. 1;

FIG. 3 is a sectional view of a combined electret and capacitor electrode;

FIG. 4 is a diagram showing the intensity distribution of the electrical field of the electrode of FIG. 3;

FIG. 5 is a sectional view of a capacitor electrode composed of two areas; and

FIG. 6 is a diagram showing the intensity distribution of the electrical field of the electrode of FIG. 5.

### DETAILED DESCRIPTION OF THE INVENTION

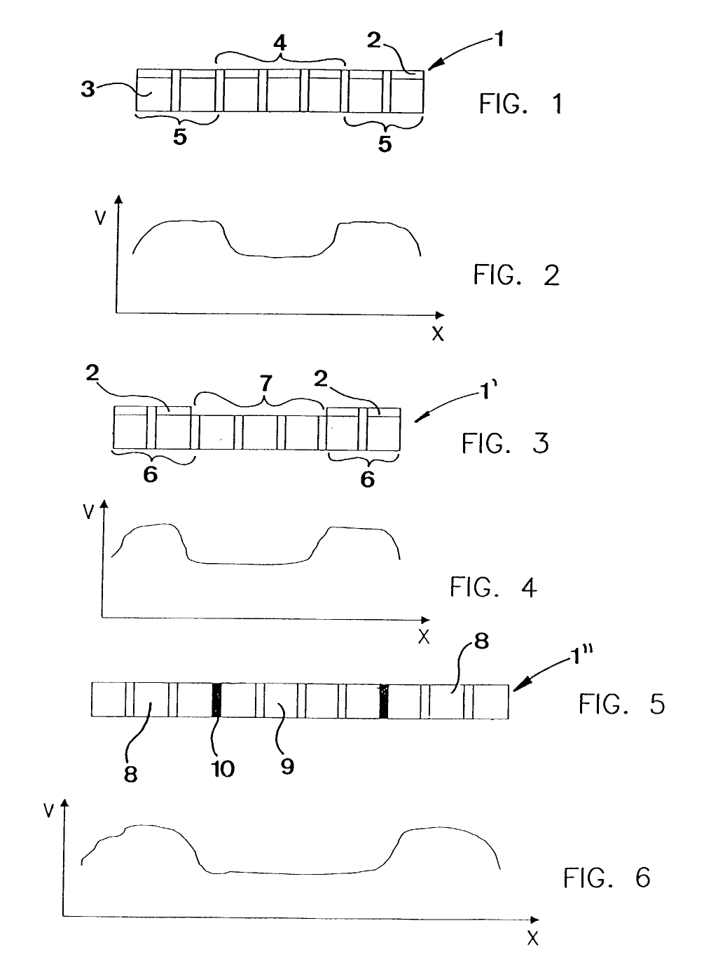

FIG. 1 is a vertical sectional view of an electrode 1 with a substrate 3 coated with a Teflon layer 2. In accordance with the present invention, the density of the electrons applied to the Teflon layer 2 is not uniform over the surface thereof; rather, the density is higher in the border area 2 than in the central area 4. As a result of this distribution, an electrical field exists between the illustrated electrode and the diaphragm, not shown, which has an intensity distribution as shown in FIG. 2. The intensity is significantly higher in the border area 5 than in the central area 4, so that the danger of “gluing” is significantly reduced in this sensitive area. Moreover, the pickup pattern of the microphone is favorably influenced.

FIG. 3 shows a modification of the invention in which the electrode 1′ of an electrostatic microphone transducer constitutes a combination of two partial electrodes 6, 7, wherein the partial electrode 6 operates in accordance with the electret principle and the partial electrode 7 operates in accordance with the capacitor principle. The annular partial electrode 6 in the peripheral area is coated with a Teflon layer, as is conventional electret electrodes, wherein the Teflon layer is charged with charge carriers in the conventional manner. The central circular partial electrode 7 is constructed as a metal electrode, as is conventional for capacitor electrodes. FIG. 4 shows the intensity distribution of the electrical field between the electrode of FIG. 3 and the diaphragm, not shown, of the microphone transducer.

Of course, it is possible to provide the central area with an electrode operating in accordance with the electret principle and to provide the border area with an electrode operating in accordance with the capacitor principle; this may be particularly advantageous because of the higher charge density which can be achieved in electrodes operating in accordance with the capacitor principle as compared to those operating in accordance with the electret principle.

FIG. 5 shows the electrode 1″ of the electrostatic microphone transducer which operates in accordance with the capacitor principle and which is composed of two partial electrodes 8, 9, which are electrically insulated from each other. The two partial electrodes, which are separated by an electrically insulating annular area 10, can be charged with different charge densities simply by applying different voltages. It is apparent that the magnitude of these voltages may also be controlled directly as desired by the user, so that a simple and subtle adjustment to the respective needs and fields of application can be achieved.

FIG. 6 shows the intensity distribution of the electrical field between the electrode according to FIG. 5 and the diaphragm, also not shown in this example, of the microphone transducer.

The invention is not limited to the illustrated embodiments; rather, various modifications are possible. For example, the distribution of the charges may certainly deviate from the circular or annular shape if this distribution is particularly preferred because of the additional effect of reducing the danger of “gluing”. Since the oscillation modes of the diaphragm may also have configurations which are not rotationally symmetrical with respect to the middle of the diaphragm, it may be advantageous to select star-shaped or other distributions in order to particularly emphasize or weaken the sound frequencies resulting from these types of oscillations.

If more than two areas with different charge densities are to be provided, it is useful to also provide more than two charge densities. As a result, particularly when providing several areas which operate in accordance with the capacitor principle, the now possible individual adjustment of the individual areas can lead to very finely adjustable and still easily attainable characteristics of the capsule.

When familiar with the features of the present invention, it is easily possible for those skilled in the art to determine the appropriate shapes and charge densities or charge density ratios.

The invention is not limited by the embodiments described above which are presented as examples only but can be modified in various ways within the scope of protection defined by the appended patent claims.

We claim:

1. An electrostatic microphone capsule comprising a diaphragm adapted to be subjected to a sound field and excited to oscillate by the sound field, and an electrode mounted at a distance from the diaphragm, wherein the electrode comprises at least two areas having different charge densities.

2. The microphone capsule according to claim 1, wherein the at least two areas comprise an at least essentially circular area and an at least essentially annular area.

3. The microphone capsule according to claim 1, wherein at least one of the areas of the electrode is configured to operate in accordance with the electret principle and another of the areas is configured to operate in accordance with the capacitor principle.

4. The microphone capsule according to claim 1, wherein the at least two areas of the electrode are configured to operate in accordance with the capacitor principle and are adapted to be connected to different voltages.

5. The microphone capsule according to claim 4, wherein the voltages are adjustable by a user of the microphone capsule.
